(19) United States
(12) Patent Application Publication
(10) Pub. No.: US 2013/0248453 A1
(43) Pub. Date: Sep. 26, 2013

(54) METHOD AND EQUIPMENT FOR CONCENTRATION OF PARTICLES IN A LIQUID

(71) Applicant: Cédric Allier, Grenoble (FR)

(72) Inventor: Cédric Allier, Grenoble (FR)

(73) Assignee: COMMISSARIAT A L'ENERGIE, Paris (FR)

(21) Appl. No.: 13/988,473

(22) PCT Filed: Nov. 17, 2011
(86) PCT No.: PCT/EP11/70395

§ 371 Date: Jun. 11, 2013

(30) Foreign Application Priority Data
Nov. 19, 2010 (FR) 10 59529

(51) Int. Cl. B03C 1/02

(52) U.S. Cl. CPC B03C 1/02
USPC 210/695; 210/222

(57) ABSTRACT

A device concentrating particles in a liquid. The device includes a magnet facing a side wall of a receptacle, free to move vertically to progressively reduce volume facing it, in which magnetic balls carrying the particles of interest accumulate, so as to concentrate these particles.

This invention relates to a method and equipment for concentration of particles in a liquid.

It is particularly applicable to biological samples that may be present in small quantities in a liquid and which are required to be concentrated in a smaller volume sample before analyzing or treating them in another manner. The nature of the particles is not important for use of the invention, they may be biomolecules, cells, viruses or parasites, etc., provided however that these particles can be fixed on magnetic balls poured into the liquid. These techniques of fixation onto magnetic balls are already used, and the fixation agent to the balls may consist of antibodies that capture proteins, bacteria or viruses.

A conventional procedure is then to attract the balls into a determined part of the liquid volume by bringing a magnet close this part. The remainder of the liquid volume is drawn off, such that a concentration of particles has been obtained in the sample. The balls can be put back into suspension in the sample, and an elution can be made to separate the particles from the balls before removing the balls so as to leave only the particles in the liquid.

Known methods based on this technique have inadequacies. When they are used manually, they are obviously imprecise and not very reproducible; but even when they are done by a machine, the volume of concentrated sample cannot be reduced as much as would be desirable, particularly due to the difficulty in effectively attracting all the particles into a very small volume. Starting from an initial volume of 1.5 ml, a known machine can thus achieve a concentration to volumes between 25 μl and 110 μl. It is difficult to achieve a higher concentration because the magnet that would collect the balls in a smaller volume would also have to be very small and would necessarily apply lower forces and thus be less efficient, allowing a larger number of balls to escape. A concentration to volumes between 100 nl and 10 μl, in other words about one order of magnitude smaller, would be required for some applications such as a search for DNA molecules.

One purpose of this invention is to eliminate this inadequacy according to prior art and improve the capacity for concentration of particles fixed on magnetic balls in liquid volumes by better use of magnetization forces attracting these balls in a smaller portion of the liquid volume.

In its general form, it applies to a method of concentrating particles in a liquid, comprising the following steps:

A) Add a first liquid in a receptacle, the first liquid comprising magnetic balls bonded to particles;

attract the magnetic balls using a first magnet, activated in a first position, outside the receptacle and facing a wall of the receptacle, the first liquid flowing along said wall;

B) draw off all or part of the first liquid outside from the receptacle, the magnetic balls being held in place on the wall of the receptacle facing the first activated magnet;

C) resuspension of the balls in a second liquid releasing the attraction by the first magnet;

D) attraction of the balls by a second magnet activated in a second position outside the receptacle, facing a wall of the receptacle;

such that when the second magnet is activated in the second position, the surface area of the magnet facing the receptacle wall is less than the surface area of the magnet facing the receptacle wall when the first magnet is activated in the first position.

One essential characteristic of the new method is that the concentration is made by activating magnets at different successive positions on the side wall of the receptacle containing the liquid volume, its surfaces being a little smaller each time to achieve an increasing concentration of balls without the risk of allowing many to escape, such that almost the entire sample to be collected will eventually end up in a very small volume of the liquid.

Steps B and D, and even step C, are advantageously repeated several times with the effect that the risk of balls escaping from the attraction of the magnets is even lower. It is often preferable that the balls should be put back into suspension in the liquid volume after each concentration, to reduce the risk that they will stick to the wall of the receptacle and once again escape from attraction by the magnets as they are activated in positions with smaller area.

It is advantageous if the magnets used to progressively increase the concentration, and particularly the first magnet and the second magnet mentioned above, are actually a single magnet. The creation of activation positions for which the surface area facing the receptacle wall is increasingly small, can then be achieved by progressively lowering the magnet along the side wall of the receptacle containing the liquid volume, such that the sample to be collected progressively accumulates near the bottom of the receptacle. Magnet rotation movements may also be applied to achieve this. As the sample is gradually lowered in the receptacle, liquid volumes with a progressively decreasing depth can be used to achieve resuspension to fully immerse the sample collected on the wall, which guarantees an increase in the concentration without the risk of losing many balls in the sample, due to complete immersion of the sample.

The magnet may be activated by bringing it close to the receptacle wall, particularly if it is a permanent magnet, or by switching it on if it is an electromagnet, or by retracting a screen impermeable to electromagnetic radiation. Resuspension may be achieved by application of ultrasounds using magnetic or mechanical means.

The invention also relates to equipment for the concentration of particles in a liquid comprising a receptacle, means of adding or drawing off liquid in or from the receptacle and a magnet placed outside the receptacle and in front of a vertical side wall of the receptacle, characterised in that it comprises a means of translating the magnet in the vertical direction along the side wall. The magnet free to move along the wall in vertical translation gradually lowers the magnetic balls to the bottom of the receptacle and in the remaining liquid volume.

In one favourable construction, the magnet has one thinned end facing the wall that extends in the vertical direction along the side wall. The concentration of the magnetic field along a vertical line with a gradually decreasing height facilitates efficient and progressive concentration of particles in an increasingly smaller volume sample.

One possible subtlety with such a magnet consists of rotating it about a horizontal axis passing through the receptacle, such that the sample remaining at the end of the procedure may be very small, corresponding to the width of the magnet.

The receptacle may advantageously be cylindrical with a much greater height than its diameter, of the order of five or ten times or even more, in order to enable greater concentration.

The invention will now be described in more detail but purely for illustrative purposes with reference to the following figures:

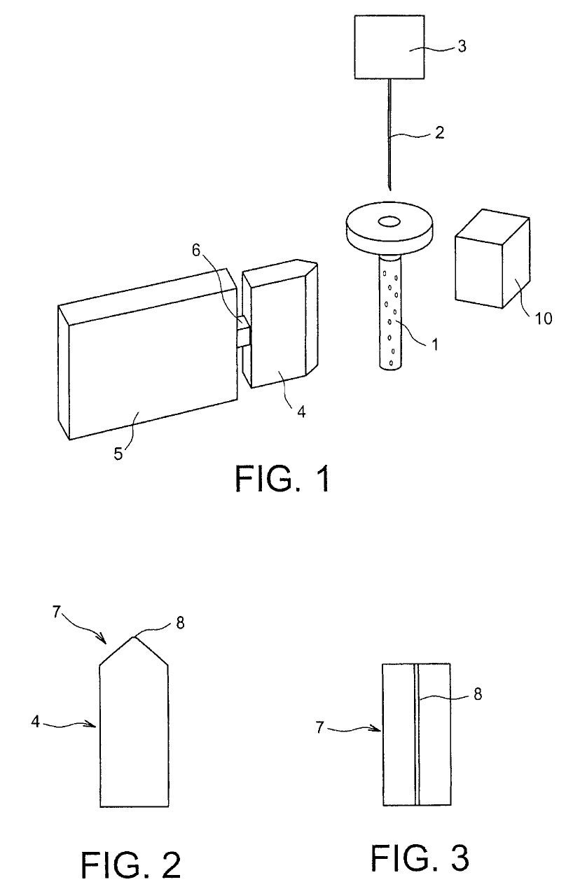

FIG. 1 is a view of the equipment,

FIGS. 2 and 3 show detailed views of the magnet,

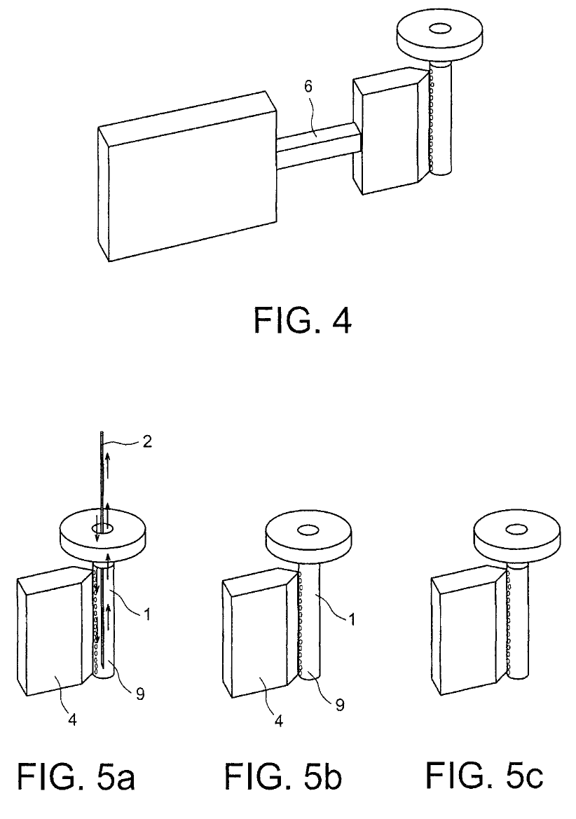

FIG. 4 shows a view of the equipment while it is being used;

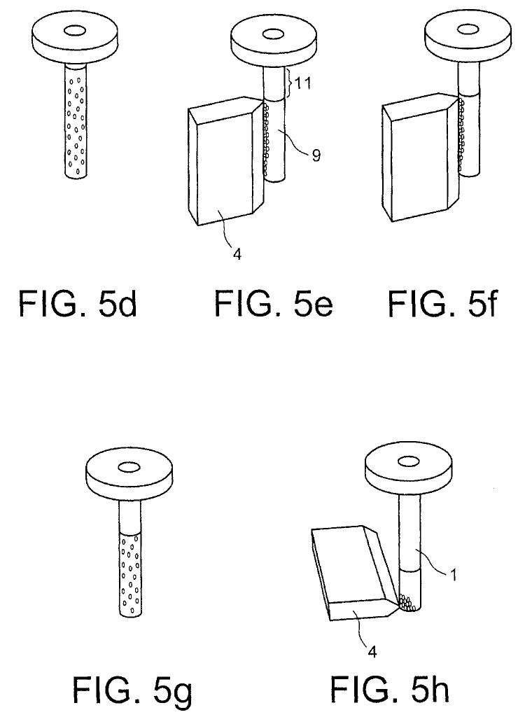

FIGS. 5a to 5h show steps in the method;

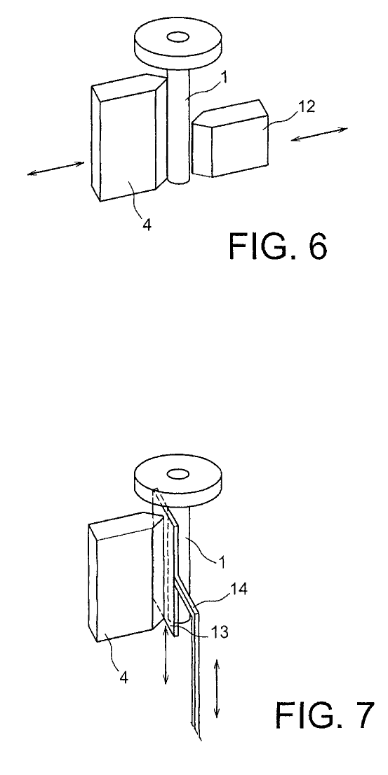

and FIGS. 6 and 7 show two variant embodiments of the equipment.

Refer to FIG. 1. The sample to be concentrated was poured into an elongated cylindrical receptacle (1) that may be 2.5 cm high and 2.5 mm in diameter. The receptacle (1) is open at the top, and a syringe needle (2) extends above it; this needle forms part of an equipment (3) not shown in detail, to inject or draw in liquid, which can also lower the needle to any depth in the receptacle (1). The receptacle (1) may be used with another much larger volume receptacle communicating with it and extending above it. This upper receptacle is not shown in the figures and in any case it will be empty when the invention is being used, but it can then be used to contain other liquids, particularly for analysis of the sample after it has been concentrated.

The equipment also comprises a magnet (4) controlled by a motor device (5) to which it is connected through a pin (6) at the back. The motor device (5) for example comprises carriages mounted on slides and motors associated with them, so as to move the pin (6) and the magnet (4) along the vertical direction, along the horizontal direction towards the receptacle (1), and to pivot the pin (6) and the magnet (4).

The magnet is shown in FIGS. 2 and 3. It is thinned and beveled at its front part (7), and ends up on a narrow end face in the form of an elongated blade (8) extending generally along the vertical direction. Its dimension may be 20×20×8 mm³ in the parallelepiped shaped main part with a depth of 4 mm in the front part (7), and the blade (8) may be 0.5 mm wide. Its material may be sintered N48 NdFeB with remanence Br=1.4 T.

An ultrasound application module (10) is used with the device.

A sample containing magnetic balls onto which particles to be collected are fixed, was injected through the needle (2) into the receptacle (1). The magnet (4) may be brought close to the receptacle (1) into a first position to attract the balls in order to collect them, as shown in FIG. 4; the blade (8) is tangent to a generating line of the vertical cylindrical side wall of the receptacle (1) and therefore attracts most of the balls onto this generating line. This is shown in FIG. 5a, the balls being marked as reference (9). Alternating injections and suctions of the sample through the needle (2) are possible during this period, most of the balls accumulating close to the magnet (4), until the entire sample has been added into the receptacle (1). Alternately, the liquid in the sample, namely the first liquid, flows continuously in the receptacle, along the wall located facing the magnet (4). This phase makes it possible to collect the greatest possible number of particles along the wall facing the magnet.

The liquid in the sample may be completely drawn off and replaced by another liquid called the second liquid for concentration purposes, the balls remaining bonded to the wall of the receptacle (1). FIG. 5b shows the situation in which the liquid was drawn off from the receptacle (1), and FIG. 5c shows the situation following injection of the second liquid replacing the first liquid.

FIG. 5d shows the next step: the magnet (4) is withdrawn and the ultrasound application module (10) is started up to put the balls (9) into suspension in the liquid and prevent them from bonding to the wall of the receptacle (1). Stirring may be done by other appropriate means, for example magnetic or mechanical means.

The magnet (4) returns in contact with the side wall of the receptacle (1) in the next step in FIG. 5e, but it has been lowered, and a volume (11) of floating liquid appears above it. In other words, the magnet (4) is placed in a second position. Preferably, the liquid contained in the receptacle is made to cover the surface of the wall placed facing the magnet when the magnet is arranged in its first position. The balls (9) leave this floating volume (11) and accumulate over the height of the magnet (4), with a greater concentration than before. In this second position, the surface area of the magnet facing the wall is smaller than when the magnet is placed in its first position. This is due to translation of the magnet between the first and the second position. The result is that the same quantity of balls is collected but over a smaller surface area, leading to a concentration effect.

The next step shown in FIG. 5f consists of drawing in the floating volume through the needle (2); and the step in FIG. 5g similar to that in FIG. 5d consists of resuspending the balls (9) in the volume remaining after the magnet (4) has been removed. It is also possible to draw off all the second liquid while keeping the magnet applied in contact with the receptacle wall and then to inject a third liquid with a smaller volume than the second liquid. The volume of the third liquid will be such that it covers the tube wall placed facing the magnet when the magnet is in its second position.

The previous steps are repeated by bringing the magnet (4) closer several times each time after lowering it, such that the liquid volume occupied by the balls (9) that follow the movements of the magnet (4) while leaving the floating volume, continually reduces. The magnet (4) may be lowered by a few millimetres in each step. In a final step, the magnet (4) may be rotated to bring the blade (8) into the horizontal position, and therefore to attract the balls (9) over a very small height, advantageously at the bottom of the receptacle (1); they are then extremely concentrated (FIG. 5h). Thus, the magnet may be translated or rotated between two successive positions.

The ultrasound application module (11) is used one last time, the magnet (4) is removed, and the balls (9) are put back into suspension in the remaining liquid that can be drawn in through the needle (2) or used in another manner.

Thus, in general:

A) a first liquid is added into a receptacle, said first liquid containing magnetic balls. Magnetic balls contained in the first liquid are collected along the wall of the receptacle when the magnet is activated in a given position called the first position. In this way, a quantity of balls is kept in contact with the receptacle wall facing the magnet;

B) all or some of the first liquid is drawn off, the magnet always being activated so as to hold the collected balls in contact with the wall;

C) a second liquid is added, the magnet then being deactivated, such that the balls are immersed in the liquid. Preferably, the second liquid extends over the entire area facing the magnet when this magnet is activated in the first position. This means that all balls collected in contact with the receptacle wall can be immersed in the second liquid. Preferably, the particles are put back into suspension through an external means mentioned above;

D) the magnet facing the outside wall of the receptacle is activated in a second position, such that when the magnet is thus activated, the area of the magnet facing the receptacle wall is less than the area of the magnet facing the receptacle wall when the magnet was activated in the first position. The magnet may have been moved between said first and second positions, for example in translation and/or in rotation.

Steps B) to D) may be repeated, the magnet changing from position n to position n+1 between step D) in iteration i to step D in the next iteration.

This method may be terminated by a step (E) during which a final liquid is added, such that the final liquid is in contact with the surface facing the magnet when the magnet is activated according to the previous step D.

The magnet is said to be activated when the magnet is arranged so as to apply an attraction force on the magnetic particles contained in the liquid. Thus, activation may include:

bringing the magnet close to the outside surface of the receptacle;

retraction of a screen, between the magnet and the outside surface of the receptacle;

activation of an electromagnet, when the magnet is an electromagnet.

Although the example described above is limited to the use of a single magnet, the invention includes the use of several distinct magnets. Thus, a first magnet is activated in steps A) and B) described above; at the same time, a second magnet is activated in step D).

In the example embodiment described with reference to FIGS. 5a to 5h, the first and the second magnets are coincident.

FIGS. 6 and 7 show two possible variant embodiments for the equipment. The embodiment in FIG. 6 shows a second magnet (12) that may be placed facing the wall of the receptacle (1) like the magnet (4) mentioned above. The second magnet (12) is activated in a second position facing the wall of the receptacle (1), the area of which is smaller than the area of the first magnet (4), in other words this magnet is used in a subsequent concentration step, for example corresponding to the step in FIG. 5e. The magnets are not activated at the same time. If they are permanent, they may be withdrawn using a motor device corresponding to that shown in FIG. 1, except that in this case, there is no point in providing any means of vertical translation of the magnets along the axis of the receptacle (1); if electromagnets are used, they will be energized at different times; screens impermeable to a magnet field may also be used as in the following embodiment, with one screen being associated with each magnet and being activated separately. The magnets (4 and 12) in this case are placed at different angular sectors around the receptacle (1); it would be possible to install other magnets to increase the number of concentration steps.

The embodiment in FIG. 7 includes the magnet (4) already described, but in this case it is assumed to be immobile, and it is actuated by a screen (13) impermeable to electromagnetic radiation and which is placed between its front part (7) and the wall of the receptacle (1). Attraction by the magnet (4) occurs when the screen (13) is retracted, which can be controlled by a motor device (14) shown partially. It should be noted that if the movement of the screen (13) is vertical, it will be possible to only mask an upper portion of the magnet (4) using this screen, and thus reproduce progressive concentration steps as shown in the embodiment in FIG. 5, each time hiding a larger upper portion of the magnet (4).

1-12. (canceled)

13. A method of concentrating particles in a liquid, comprising:
adding a first liquid in a receptacle, the first liquid comprising magnetic balls bonded to particles;
attracting the magnetic balls using a first magnet, activated in a first position, outside the receptacle and facing a wall of the receptacle, the first liquid flowing along the wall;
drawing off all or part of the first liquid outside the receptacle, the magnetic balls being held in place on the wall of the receptacle facing the first activated magnet;
resuspending the balls in a second liquid releasing attraction by the first magnet;
attracting the balls by a second magnet activated in a second position outside the receptacle, facing a wall of the receptacle;
wherein when the second magnet is activated in the second position, a surface area of the magnet facing the receptacle wall is less than a surface area of the magnet facing the receptacle wall when the first magnet is activated in the first position.

14. A method according to claim 13, wherein the second magnet and the first magnet are a single magnet.

15. A method according to claim 14, wherein the second position corresponds to a rotation or a translation of the magnet from the first position.

16. A method according to claim 13, wherein when the balls are put back into suspension, the second liquid extends along the wall facing the first magnet when the first magnet is activated in the first position.

17. A method according to claim 12, further comprising:
drawing off all or part of the second liquid; and
putting the balls back into suspension in a third liquid, the third liquid extending along the wall facing the second magnet when the second magnet is activated in the second position.

18. A method according to claim 12, wherein the drawing off and the attracting the balls by the second magnet operators are repeated plural times, each time activating a magnet with a surface area facing the receptacle wall, that is smaller.

19. A method according to claim 18, wherein the resuspending is repeated after each drawing off operation.

20. A method according to claim 12, wherein the resuspending is achieved by application of ultrasounds.

21. An equipment for concentration of particles in a liquid, comprising:
a receptacle;
means for adding or drawing off liquid in or from the receptacle;
a magnet, placed outside the receptacle and in front of a vertical side wall of the receptacle; and
means for translating the magnet in a vertical direction along the side wall.

22. An equipment according to claim 21, wherein the magnet includes one thinned end facing the wall that extends in the vertical direction along the side wall.

23. An equipment according to claim 22, further comprising means for rotating the magnet about a horizontal pin passing through the receptacle.

24. An equipment according to claim 21, wherein the receptacle is cylindrical with a height at least five times greater than its diameter.
